(19) United States
(12) Patent Application Publication
(10) Pub. No.: US 2005/0279177 A1
(43) Pub. Date: Dec. 22, 2005

(54) Strain gauge apparatus having a point-distributed sensor

(76) Inventors: Yu-Hsiang Hsu, Taipei (TW); Chih-Kung Lee, Taipei (TW)

Correspondence Address: J C PATENTS, INC., 4 VENTURE, SUITE 250, IRVINE, CA, 92618, US

(21) Appl. No.: 10/870,782

(22) Filed: Jun. 16, 2004

(51) Int. Cl. G01L 1/00

(52) U.S. Cl. 73/775

(57) ABSTRACT

A strain gauge apparatus having a point-distributed sensor for measuring the strain of a mechanical structure. The strain gauge comprises a thin elongated piezoresistive lamina with a shape contour that is symmetric with respect to the longitudinal axis thereof, and the width of the lamina at the center along the longitudinal axis is minimum for the entire lamina length. The point-distributed strain gauge apparatus measures both static and dynamic deformation in the measured structure at a precise location aligned to the targeted center of the sensor lamina.

### BACKGROUND OF THE INVENTION

1. Field of the Invention

This invention relates in general to a strain gauge for measuring strain information in a structure under mechanical load In particularly, this invention relates to a resistance strain gauge apparatus having a point-distributed sensor for the measurement of true strain at an exact point on a structure sustaining static or dynamic deformation.

2. Technical Background

Strain gauge is a device for measuring the strain information on the surface of a solid that occur when the body is deformed. A strain gauge is comprised of a sensor laminate; it can be adhered onto the surface or embedded inside the body of a testing structure for measuring strain information of interest. With proper arrangement, complete strain distribution information of a test structure can be measured, such as utilizing a Rosette strain gauge. They are used either to obtain information from which stresses in bodies can be calculated. Or they are to act as indicating elements on devices for measuring such quantities as force, pressure, and acceleration when the collected information is properly converted into the adequate physical quantities.

Basic configuration of traditional resistance strain gauges practically has not changed since they are incepted. FIG. 1 is a perspective view illustrating a conventional strain gauge 110, whose sensor lamina 112 is deployed to the surface 122 of a measured structure 120. In the gauging setup 100, electrical contact terminals 113 and 114 at opposite ends of the generally elongated lamina 112 are connected to an electrical instrumentation (not shown) via their corresponding electrical nodes 115 and 116 for the measurement of electrical resistance across the ends of the lamina.

Ideally, a resistance strain gauge such as that of FIG. 1 is expected to serve as a sensor for the measurement of local strain information at its deployed location of a structure. However, this typical resistance strain gauge is only capable of turning out an approximation of the actual strain information at the location generally identified by the dot-lined area 124 where it is deployed.

Strain gauging may be concerned with the measurement of static or dynamic deformations in a test structure. Strain in an examined structure is the information in the spatial domain, strain gauging by a strain gauge is thus discussed in the spatial domain as it performs measurement. When the size of a strain gauge is small enough compared to the variation of the monitored strain, the monitored strain can be considered as constant, and the strain gauge treated as a point sensor that measures the local strain at a specific point.

For strain gauging in typical structural systems, point and distributed sensors are used. A point sensor is used to construct a strain gauge that has a signal pick-up lamina with an integral surface area much smaller than the size of the sensed structure. Its sensed information generally represents the strain characteristics of the structure at the specific point of sensor deployment.

On the other hand, a distributed sensor has a signal pick-up lamina with an integral surface area comparable to the overall size of the sensed structure. The information it picks up reflects the general bulk characteristics of the structure, and, traditionally, sufficient prior knowledge to the general characteristics of the structure needs to be available so that an adequate sensor shape configuration can be determined for the sensing of the structure with accuracy to an acceptable degree.

A fundamental assumption for the theory of operation of a traditional resistance strain gauge is that the size of its sensor segment must be small compared to the dimensional extent of strain variations in the sensed system. Under the assumption, the monitored strain can substantially be considered constant. When the extent of strain variations is not sufficiently large compared to the size of the measuring sensor, accuracy of the measurement becomes deteriorated. This problem is severe in systems with dynamic strain, since multiple wavelengths or frequencies may exist simultaneously in an excitation.

Since infinite resonance modes are possible in a vibrating finite structure, the above assumption for proper analysis of a resistance strain gauge only holds true in low-order resonance modes, in which long wavelengths (of vibration) can be certain. It is possible to consider and analyze a traditional resistance strain gauge as a point sensor in low-order resonance modes. A traditional piezoresistive strain gauge, however, must be considered as a distributed sensor in high-order resonance modes. However, resistance measured in high-order resonance modes is no longer a proper representative of the true mechanical strain at the center point of the strain gauge.

Here, for the purpose of the description of the present invention, together with the problems this invention seeks to solve, it suffices to review the mathematical analysis on the sensor equation of a piezoresistive thin film in the following paragraphs.

It was discovered that when certain these known piezoresistive material were subjected to mechanical stress, the extent of the corresponding alteration in their resistivity, an electrical characteristic factor to pick up as the measure for the investigated strain, was about two orders of magnitude larger than the body deformation, another measurable factor. This can be shown by looking into the nature of electrical resistivity in a material, either semiconductor piezoresistive or pure resistive.

FIG. 3 illustrates a generalized piezoresistive sensor lamina with an arbitrary-shaped electrode deployed to the surface of an examined structure. The gauging setup 300 is used herein for the description of the mathematical modeling of strain gauges discussed in the descriptive text of the present invention. The model system 300 illustrates a piezoresistive device 310 that has an arbitrary shape and bond to the surface 322 of a structure 320 under mechanical load. Strain produced inside the stressed structure 320 is reflected in the adhering piezoresistive layer 312 in terms of alteration of resistance appearing across the tapped terminals 313 and 314 of the layer 312. Note that the model 300 of FIG. 3 serves both to review the basis of the traditional piezoresistive strain gauge and to explain the underlying principle of the innovative strain gauge apparatus as taught by the present invention.

By definition, resistance, R, of a piece of material is
R=ρ(L/wh), (1)
where ρ is the resistivity, L the length, w the width, and h the thickness of the piece of material examined. This assumes that the cross section inside the examined piece of sensor material 312 is generally described by a width w and thickness h, as is depicted in FIG. 3. Note that the width of the sensor lamina 312 is expressed as a function w(x) of the lengthwise variable x while the thickness h is considered to be substantially constant. The cross section of analysis is as generally identified in the drawing by reference numeral 318, across which the gross electrical current I is measured between terminals 315 and 316. Note here that the piezoresistive lamina 312 of FIG. 3 is described in a mathematical system with the orthogonal x, y, and z spatial orientations aligned to the longitudinal, the width, and the thickness directions of the lamina respectively. This is indicated by the coordinate system outlined in the drawing.

In the model system 300 of FIG. 3, the resistance at a designated location x along the path of the electrical current, or the longitudinal direction, in the arbitrary-shaped piezoresistive lamina 312 measures according to the following equation

$$dR = ρ \frac{dx}{w ( x ) t} . \qquad ( 2 )$$

Since the sensor 312 is in the form of a laminate, the scale in the z dimension is taken to be substantially constant, h. The width of the lamina 112, however, is expressed as a function of the x dimension as w(x).

Thus, the total resistance of the entire piezoresistive lamina 312 of FIG. 3 between the end terminals 313 and 314 is

$${R}_{r} = {\int }_{- L / 2}^{L / 2} ⅆ R = \frac{ρ}{t} {\int }_{- L / 2}^{L / 2} \frac{dx}{w ( x )} . \qquad ( 3 )$$

Assume that the piezoresistive lamina 312 of FIG. 3 is relatively slender. The average width of the lamina is relatively small compared to the total length L between the end terminals 313 and 314. Thus, the transverse deformation of the lamina 312 can be derived, and the variation of resistance for all integral element along the x direction can be expressed as ΔR=Gε_{L}R. The variation of resistance for the designated section 318 in the system 300 can thus be derived from the following equation

$$\frac{1}{Δ {R}_{L}} = {\int }_{0}^{w ( x )} \frac{1}{Δ R} ⅆ y = {\int }_{0}^{w ( x )} \frac{1}{G {ɛ}_{L} {R}_{e}} ⅆ y = \frac{w ( x )}{Δ R} = \frac{w ( x )}{G {ɛ}_{L} {R}_{e}} , \qquad ( 4 )$$

wherein ΔR_{L} designates the variation of the resistance for an integral section 318 of the lamina 312.

Total variation of resistance of the lamina 312 between ends 313 and 314 thus becomes

$$Δ {R}_{t} = {\int }_{- L / 2}^{L / 2} {ΔR}_{t} = \frac{ρ G}{t} {\int }_{- L2}^{L / 2} \frac{{ɛ}_{L} ( x )}{[ w ( x ) ]} ⅆ x \qquad ( 5 )$$

wherein ΔR_{L} represents the total variation of resistance in the analyzed lamina 312. When a Wheatstone bridge is employed for measurement, the measured signal seeks to be proportional. There is thus the general solution

$$\frac{Δ {R}_{t}}{{R}_{t}} = \frac{G {\int }_{- L / .2}^{L / 2} \frac{{ɛ}_{L} ( x )}{w ( x )} ⅆ x}{{\int }_{- L / 2}^{L / 2} \frac{dx}{w ( x )}} \qquad ( 6 )$$

where ε_{L}(x) is the longitudinal strain, w(x) the width of the lamina, ΔRₜ the total variation of the resistance, and Rₜ the original resistance without deformation.

Note that the signal picked up by the Wheatstone bridge is an integral of the strain ε_{L}(x) weighted by [w(x)]. If the sensor piezoresistive lamina used were substantially uniform in shape, i.e., if w(x) is a constant and equals w, then Eq. (6) can be simplified as

$$\frac{Δ {R}_{t}}{{R}_{t}} = G {\int }_{- L / 2}^{L / 2} {ɛ}_{L} ( x ) ⅆ x . \qquad ( 7 )$$

If the strain in the structure 320 as monitored by the piezoresistive lamina 312 was substantially constant, Eq. (7) can further be reduced to

$$\frac{Δ {R}_{t}}{{R}_{t}} = G {ɛ}_{L} , \qquad ( 8 )$$

which confirms to the measurement result obtained utilizing traditional strain gauges.

Consider the case in which the strain distribution in an examined structure is not uniform (constant) substantially within the area monitored by the strain gauge. Assume that a piezoresistive lamina used as a sensor gauge is mounted on the top surface of an elongated thin and narrow plate. The strain ε_{L}(x) becomes an out-of-plane strain and is equal to −∂²w/∂². Substituting this strain in Eq. (7) and there is

$$\frac{Δ {R}_{t}}{{R}_{t}} = G [ \frac{\partial w ( - L / 2 )}{\partial x} - \frac{\partial w ( L / 2 )}{\partial x} ] , \qquad ( 9 )$$

which is proportional to the difference of the bent angles in the examined elongated plate at locations L/2 and −L/2. In this case, the measurement of the strain information can become one that measures another physical quantity, namely, the angles bent.

Since, traditionally, the length of a typical gauge is usually relatively short, the bending angles at locations L/2 and −L/2 respectively are therefore substantially the same. Output signal can thus be considered as an approximation to a spatially differential signal. Therefore, Eq. (9) can be rewritten as a difference quotient:

$$\frac{Δ {R}_{t}}{{R}_{t}} = \frac{G}{w} \frac{[ \frac{\partial w ( L / 2 )}{\partial x} - \frac{\partial w ( - L / 2 )}{\partial x} ]}{[ ( L / 2 ) - ( - L / 2 ) ]} \approx \frac{{\partial }^{2} w ( 0 )}{\partial x} . \qquad ( 10 )$$

Note that the signal of this uniform strain gauge can be considered to be that of a point sensor that measures the mechanical strain as long as its size is sufficiently small compared to the variation of the one order integration of the bending angle. If the gauge length was not sufficiently short and substantially down to the scale of the wavelength of the stress vibrations, the above approximation would not hold. If so, the measured strain would not be reflecting the true strain at the center point of the strain gauge, i.e., at the zero point (x=0) along the lengthwise dimension of the sensor, and the strain gauge can not be considered as a distributed sensor. This is attributable to analytical considerations in the spatial domain, which are necessary in both the static and the dynamic systems.

Thus, as can be observed from Eq. (8) above, the length factor L, of a traditional resistance strain gauge is directly related to its practical usefulness. Eq. (8) clearly indicates the fact that the length L needs to be sufficiently large for the detecting instrumentation, Wheatstone bridge in many occasions, to pick up the resistance with reasonable precision. In order to improve this length factor, it has become a wildly-accepted approach to electrically connect a number of sensor segments in series arranged in a zigzag, or grid, pattern. FIG. 2 illustrates the pattern of such a traditional resistance strain gauge. The plane view outlines the typical gridwork of a conventional strain gauge 210 containing a number of series-connected sensor segments 231, 232, . . . and 238 formed on the surface of a carrier sheet 240 (paper for example).

However, there are at least a few serious problems that hinder the true usefulness of traditional resistance strain gauges. First, the signal picked up by the instrumentation that represents the strain in the detected structure by the gauge sensor lamina is a gross representation. A sensor lamina does not measure the strain of a precise point of the gauged target structure. Rather, the measurement is a representation that is an aggregation of the total resistance along the entire segment of the sensor lamina. The total resistance, in turn, is reflecting the aggregated strain information of all the points covered by the strain-measuring lamina. Such aggregation information is only sufficient for an estimation of the true strain. It is by no means the true strain itself

Besides, since the information is an aggregation, the total surface area of the lamina must be constrained to be as small as possible. Limitation of lamina size, however, is directly translated into difficulties in resistance measurement for the part of instrumentation. Although series or grid connection of multiple sensing laminae such as the device of FIG. 2 does increase the overall resistance to levels suitable for the electrical instrumentation, however, the entire area 224 generally covered by all the series-connected sensor segments 231, 232, . . . and 238 is far from a precise point. As is comprehensible, if the strain distribution around the gauge device 210 is sufficiently uniform the collected strain information can be an approximation to the strain at the central point generally identified by the dot-circle 225.

This limitation becomes even more acute when strain gage are used in MEMS devices. There are many MEMS devices using deposited piezoresistive materials on to their structure to function as strain gages. As the geometry of MEMS devices are very small, the size of strain gage must be even smaller to ensure its functionality and basic assumptions. This makes a strain gage in MEMS device hard to utilize. First, because they are small in size, the available value of resistance cannot be large enough. Second, in the applications of dynamic systems, the functions of strain gage will fail since it cannot be considered as a point sensor any more. This limits the applications of strain gages in MEMS device. They can only be utilized in devices function in quasi-static frequency band, and special circuit design is need to deal with its low resistance.

Also, the overall grid size of the entire gauge 210 reduces the effective population density of strain gauges in a structure to be measured systematically with a multiple number of gauges.

Also, noise vibrations frequently sustained in a gauged mechanical structure interfere with the gauging. For traditional resistance-strain gauges, additional processing circuitry has to be used if these noises were to be removed in order to improve gauging precision.

### SUMMARY OF THE INVENTION

It is therefore an object of the present invention to provide a strain gauge apparatus that measures the true strain of an exact point of a mechanical structure.

It is another object of the present invention to provide a strain gauge apparatus that measures the true strain of an exact point of a mechanical structure which is not constrained to a minimal lamina size.

It is another object of the present invention to provide a strain gage apparatus that measures the true strain of an exact point of a MEMS device without having to using a small geometry to serve as a point sensor.

It is yet another object of the present invention to provide a strain gauge apparatus that measures the true strain of an exact point of a mechanical structure with high precision via removal of high-frequency noise vibrations sustained in the structure by self-filtering.

The present invention achieves the above-identified objects by providing a strain gauge apparatus having a point-distributed sensor for measuring the strain of a mechanical structure. The strain gauge comprises a thin elongated piezoresistive lamina with a shape contour that is symmetric with respect to the longitudinal axis thereof, and the width of the lamina at the center along the longitudinal axis is minimum for the entire lamina length thereof.

The present invention also provides a strain gauge apparatus for measuring the strain of a mechanical structure that comprises a plurality of thin elongated piezoresistive laminae connected electrically in series. Each of the plurality of laminae has a shape contour symmetric with respect to the longitudinal axis thereof, and the width of each of the laminae at the center along the longitudinal axis being minimum for the entire length thereof.

The present invention further provides a strain gauge apparatus for measuring the strain of a mechanical structure that comprises a thin elongated piezoresistive lamina having a shape contour symmetric with respect to the longitudinal axis thereof and conforming to a mathematical expression that is resolved analytically for a desired embedded spatial filter for inflicting an arbitrary no-phase-delay filtering effect when gauging strain, and the width of the lamina at the center along the longitudinal axis being minimum for the entire length thereof.

The present invention further provides a strain gauge apparatus for measuring the strain of a mechanical structure that comprises a plurality of thin elongated piezoresistive laminae connected electrically in series, each of the plurality of laminae has a shape contour symmetric with respect to the longitudinal axis thereof and conforming to a mathematical expression that is resolved analytically for a desired embedded spatial filter for inflicting an arbitrary no-phase-delay filtering effect when gauging strain, and the width of each of the laminae at the center along the longitudinal axis being minimum for the entire length thereof.

### BRIEF DESCRIPTION OF THE DRAWINGS

Other objects, features, and advantages of the present invention will become apparent by way of the following detailed description of the preferred but non-limiting embodiments. The description is made with reference to the accompanied drawings.

FIG. 1 is a perspective view illustrating a conventional strain gauge sensor lamina deployed to the surface of a measured structure.

FIG. 2 is a plane view outlining the typical gridwork of a conventional strain gauge containing a number of series-connected sensor segments.

FIG. 3 illustrates a generalized piezoresistive sensor lamina with an arbitrary-shaped electrode deployed to the surface of an examined structure for the description of the mathematical modeling of strain gauges.

FIG. 4 is a characteristic diagram showing the modal strain wave distribution inside an elongated cantilever plate having implemented on the surface thereof a strain gauge in accordance with a preferred embodiment of the present invention.

FIG. 5 is a perspective view illustrating the deployment of a strain gauge apparatus in accordance with an embodiment of the present invention on the surface of an elongated plate structure in a fix-free support arrangement.

FIG. 6 is a plane view illustrating the sensor lamina shape configuration of a strain gauge apparatus in accordance with a preferred embodiment of the present invention.

FIG. 7 is a plane view illustrating the sensor lamina shape configuration of another strain gauge apparatus in accordance with a preferred embodiment of the present invention.

FIG. 8 is a plane view outlining the gridwork of a strain gauge apparatus in accordance with a preferred embodiment of the present invention containing a number of series-connected sensor segments.

FIG. 9 is a perspective view illustrating the deployment of the strain gauge apparatus of FIG. 6 to the surface of an examined structure.

FIG. 10 is a perspective view illustrating the deployment of a strain gauge apparatus similar to that of FIG. 7 but made on a carrier sheet to the surface of an examined structure.

### DETAILED DESCRIPTION OF THE PREFERRED EMBODIMENTS

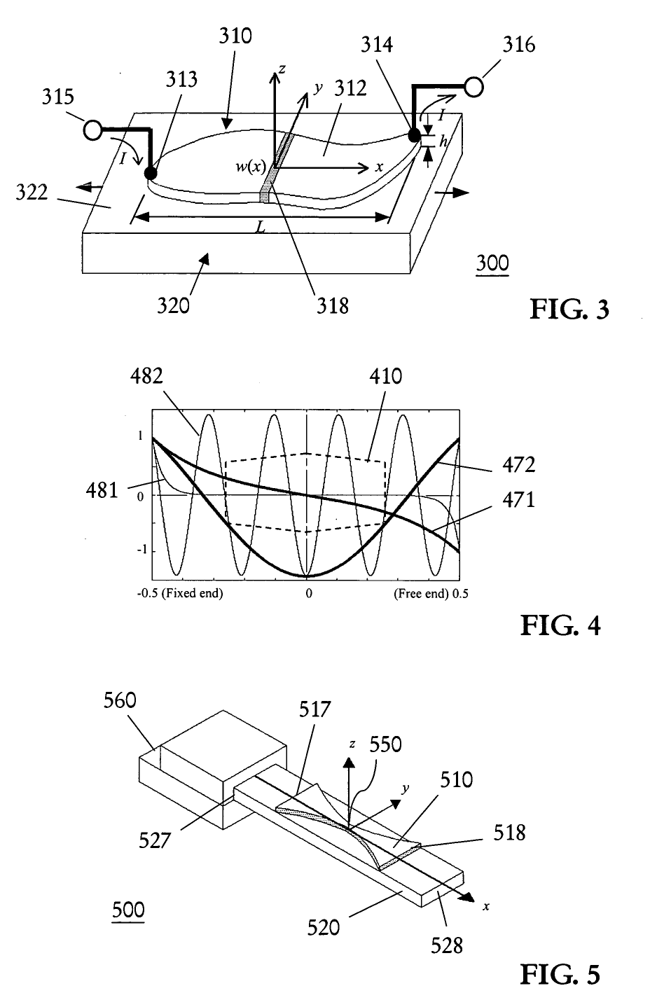

Any mathematical function can be expressed as a superposition of an even function and an odd function. The strain distribution of any deformation arising in an examined structure, when described with a mathematical function in a model such as illustrated in FIG. 3 and described above, can be one such function. Thus, the strain distribution ε(x) of a structure deformed under mechanical stress becomes
ε(x)=ε_{ε}(x)+εₒ(x) (11)
where εₑ(x) and εₒ(x), respectively, are the even and odd components of the mathematical system.

In accordance with the underlying mathematical conception of the present invention, the surface integral obtained by performing surface integration in the spatial domain can be resolved into a specific solution that facilitates a no-phase-delay low-pass filter into the transfer function of the sensor output. The idea can be outlined in the following expression [symbol]
R(x)ε(x)dx=R(x)[εₑ(x)+ε₀(x)]dx, (12)
wherein R(x) is the effective surface electrode acting as the distributed sensor, which offer itself as a weighting function to the system in the spatial domain, and the integration is performed from −a to a, which specifies the entire range covered by the distributed sensor.

It is known that the integral of two even functions or two odd functions is a real-valued function. Further, the integral of an even and an odd function is zero. Based on this, the mathematical integration described by Eq. (12), suggests that a symmetric or an anti-symmetric distributed sensor is able to implement a low-pass filter that inflicts no phase delay. The expel of phase delays in the system is important as they distort the picked-up information. This is achievable since the integration of Eq. (12), in accordance with the idea of the present invention, is able to remove the factor of complex components altogether.

Specifically, if R(x), the functional representation of the effective surface electrode (the sensor lamina), is itself an even function and explicitly designated as R_{ε}(x), then there is the relationship R_{ε}(x)=R_{ε}(−x). Under this circumstance, only the symmetric component of the strain, ε₆₈(x), which possesses even functionality, is measured, and the resultant measurement is mathematically a real value. Similarly, an odd-functioned effective surface electrode Rₒ(x) (which sustains the relationship Rₒ(x)=−Rₒ(−x)) measures only the anti-symmetric component εₒ(x). Its obtained measurement result is also mathematically a real value.

FIG. 4 is a characteristic diagram showing the even and odd components of the strain wave distribution of the first and tenth modes inside an elongated cantilever plate having implemented on the surface thereof a strain gauge in accordance with an embodiment of the present invention. For example, the first- (odd 471 and even 472) and tenth-mode (even 481 and odd 482) strain distributions for a symmetric piezoresistive sensor 410 (shown in phantom lines) are shown in the drawing. The characteristics diagram assists to explain how a symmetric piezoresistive sensor device is able to introduce a no-phase-delay low-pass filter in the sensor transfer function.

It is obvious from FIG. 4 that in high-order modes, a symmetric piezoresistive sensor device sustains within its structure many periods of vibrational waves, and all these waves cancel each other. In low-order modes, on the other hand, wave vibrations in the system are very slow and few cancellations occur. These are characteristics that demonstrate how a symmetric piezoresistive sensor device is able to introduce the characteristics of a no-phase-delay low-pass filter into the transfer function of a sensor device. In addition, FIG. 4 also shows that a symmetric distributed sensor does reject anti-symmetric waves.

Note that all mathematical systems used for the description of the analysis of this inventive sensor systems for strain gauging use the center point of the symmetric sensor device as the origin of the lengthwise coordinate scale. In a way this is due to the fact that sensor devices in accordance with the present invention are symmetric in shape along its longitudinal axis. This center point is referred to hereinafter as the targeted origin.

It can be shown, in the following descriptive paragraphs, that the targeted origin is the only point in the entire inventive sensor system that has no other corresponding symmetric or anti-symmetric point to warrant spatial canceling. This translates into a useful characteristics that the information of the local strain in the sensed structure that is precisely under the targeted origin is the only information that avoids cancellation. Without cancellation, the strain information remains in the sensor transfer function for detection. Such a characteristics in accordance with the present invention is both useful and beneficial to allow for the construction of several types of point-distributed strain gauge apparatuses. An innovative strain gauge apparatus of the present invention picks up strain information from the sensed structure at the point under its targeted origin without the interference by all other irrelevant vibration wavelengths present in the structure of interest.

Underlying theory for the point-distributed strain gauge apparatus of the present invention has been verified by experiments. Experimental results confirm the correct and precision measurement of the strain information at precisely-designated point location over the surface of target structure.

Consider again Eq. (6). Shape of the piezoresistive lamina can be employed to convey a weighting function to the strain distribution. Specifically, when the spatial weighting is applied to the monitored strain and the distributed piezoresistive sensor, a 1/w(x) weighting is superimposed into the monitored strain. If the weighting function 1/w(x) is suitably chosen to be identical to the weighting function R(x) in Eq. (12), Eq. (6) may then be further rearranged as

$$\frac{Δ {R}_{t}}{{R}_{t}} = \frac{G}{{\int }_{- L / 2}^{L / 2} [ 1 / w ( x ) ] ⅆ x} {\int }_{- L / 2}^{L / 2} R ( x ) {ɛ}_{L} ( x ) ⅆ x . \qquad ( 13 )$$

FIG. 5 is a perspective view illustrating a point-distributed strain gauge system 500 in accordance with a preferred embodiment of the present invention. A piezoresistive lamina 512 constructed in accordance with the concept of the present invention has its targeted origin 550 aligned to an arbitrary location on a cantilever plate 520. The elongated cantilever plate structure 520 is, in this described example, set up in a fix-free support arrangement with its fixed end 527 securedly attached to the base 560 of the system and its free end 528 left free of any constraint, as is shown in the drawing.

Placing a symmetric piezoresistive lamina with its targeted origin aligned to the point at which the strain is to be gauged, Eq. (13) can be replaced with

$$\frac{Δ {R}_{t}}{{R}_{t}} = \frac{G}{{\int }_{- L / 2}^{L / 2} [ 1 / w ( x ) ] ⅆ x} {\sum }_{i = 1}^{∞} {A}_{t} ( t ) \{ {ϕ}_{i}^{″} ( 0 ) + [ B ( a , t ) + B ( - a , t ) ] \} F ( ω ) , \qquad ( 14 )$$

wherein B(a,t) and B(−a,t) are the measured symmetric portions of the strain at the respective boundary 517 and 518 of the symmetric piezoresistive lamina 520.

In the system of FIG. 5, the local strain φᵢ″(0) in the cantilever structure 520 aligned to the targeted origin 550 of the piezoresistive lamina 510, in accordance with the present invention, can be monitored with high precision exactly on-spot. This is because that a zero phase-delay low-pass filter F(ω) is effectively introduced into the system. The strain signal thus, effectively, is low-pass filtered simultaneously as it is being picked up.

Considering the fact that most mechanical systems requiring stain gauging is characterized by the low-frequency strain signal with frequently inevitable high-frequency interfering noises, the piezoresistive lamina 510 as exemplified in FIG. 5 is particularly useful. The inherent characteristics of a low-pass filter in a strain gauge device, as is appreciable to those skilled in the art, is beneficial in that the high-band interference noises are discarded automatically. In other words, a point-distributed strain gauge in accordance with the present invention is capable of ensuring high-precision strain measurement at exactly-designated location on the measured structure.

When the weighting at the boundaries is several orders of magnitude larger than that at the targeted origin, i.e., if R(0)>>R(−L/2) and/or R(0)>>R(L/2), or, alternatively, w(0)²<<w(−L/2)² and/or w(0)² w(L/2)², the boundary terms B(a,t) and B(−a,t) can reasonably approximate zero. In this case, Eq. (13) can be adjusted and becomes

$$\frac{Δ {R}_{t}}{{R}_{t}} = \frac{G}{{\int }_{- L / 2}^{L / 2} [ 1 / w ( x ) ] ⅆ x} {\sum }_{i = 1}^{∞} {A}_{i} ( t ) {ϕ}_{i}^{″} ( 0 ) G ( ω ) . \qquad ( 15 )$$

Eq. (15) describes a distributed sensor that is able to measure the local characteristics at the origin.

Overall size of the piezoresistive lamina 510 of FIG. 5 is adjustable without alteration to its operating characteristics. If necessary, the lamina can be shrunken to a size allowing to be implemented as a point sensor, or, specifically as a strain gauge. Such small sensors/gauges can be deployed to an area of an examined structure in sufficient number so as to implement detailed monitor to the structural system.

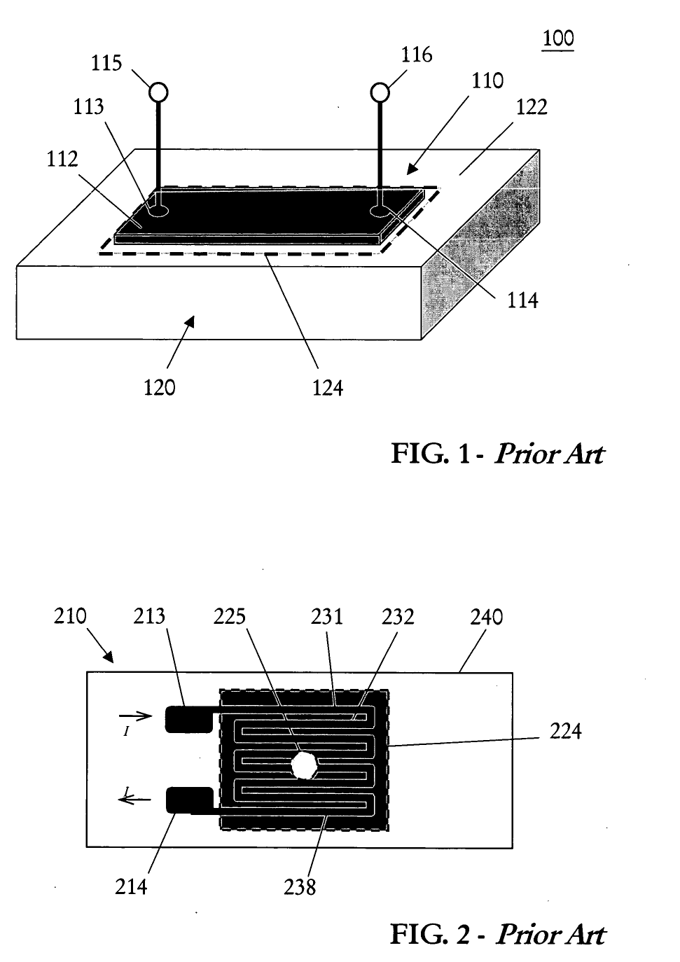

There is substantially no size limitation for the inventive point-distributed strain gauge similar to that for traditional strain gauges. For conventional strain gauges such as depicted in FIGS. 1 and 2, the overall size of the lamina needs to be minimized to be as small as possible.

On the other hand, as mentioned above, the physical size of a traditional strain gauge must be sufficiently small when compared to the wavelength of interest (mechanical vibrations). Further, from another perspective of the electrical detection instrumentation that constitutes another important component of a practical strain gauge system, the reduction of physical size of the sensing lamina is disadvantageous. Size reduction in the sensor lamina is directly translated into reduced resistance for the electrical subsystem to process. This drawback becomes a major problem as strain gages are applied as a point sensor for MEMS device. Since the geometry of a MEMS device is ranging from several thousand micrometers to several micrometers, an attempt to implement a strain gage on a MEMS device will be very hard to handle. This is because a strain gage implemented on a MEMS device need to have a much smaller size to retain its basic assumption. That is, they have to use a considerable small size with respect to the structure deformation of the attached MEMS structure to serve as a point sensor. This makes its overall resistance very small and requires a very complicated interface circuit to measure the variation of its resistance during deformation. The present invention, point-distributed strain gage, does offer a full solution to this problem By introducing the concept of symmetric piezoresistive lamina, a distributed strain gage with the ability to measure the local strain of a specific point is possible. The point-distributed strain gages can certainly using a large in size piezoresistive lamina implemented on a MEMS device and possessing point sensor characteristics and enough material to offer enough resistance value for its interface circuit. Thus the point-distributed strain gage have the powerful characteristic in MEMS application, i.e., able to have large size and resistance. This make it easy and feasible for the application in MEMS devices.

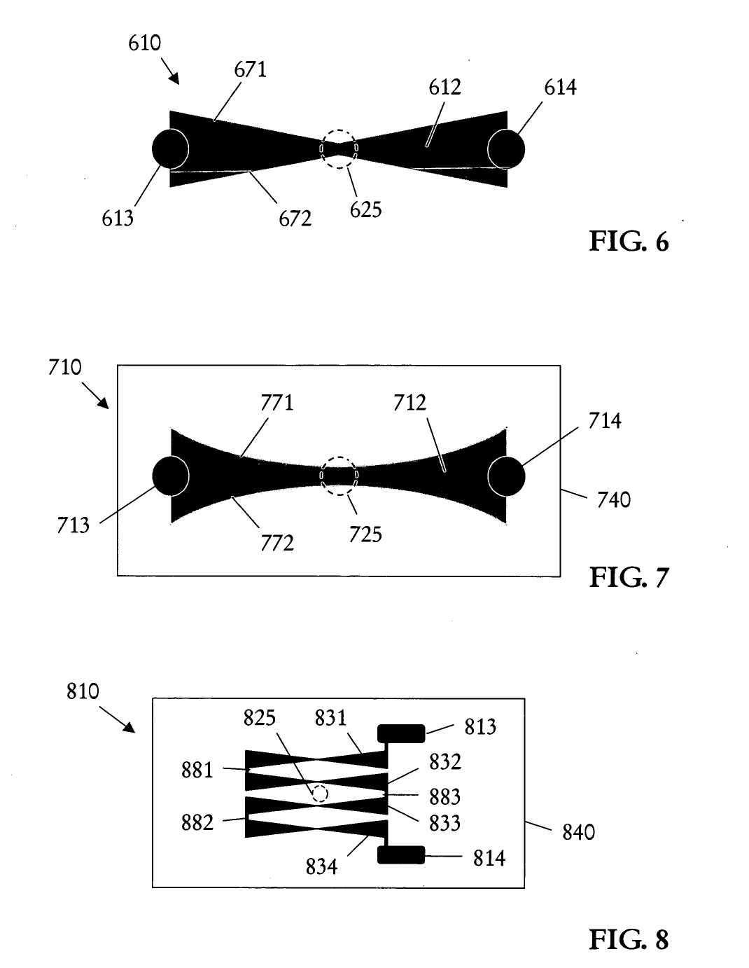

FIG. 6 is a plane view illustrating the sensor lamina shape configuration of a strain gauge apparatus in accordance with a preferred embodiment of the present invention. The strain gauge 610 has a sensor lamina 612 made, for example, of piezoresistive material. The sensor lamina 612 has a generally elongated shape, which, as is illustrated in the drawing, extends horizontally. Shape of lamina 612 is symmetrical with respect to its longitudinal axis. The strain gauge 610 thus constitutes a symmetric strain gauge apparatus of the present invention and has a targeted origin 625 at the center, as is identified by the phantom circle in the drawing. The sensor lamina 612 has a pair of electrical contact terminals 613 and 614 each located at one of the far opposite ends that can be connected to electrical instrumentation for the measurement of resistance.

Note that the width of the lamina 612 at the targeted origin 625 is substantially minimum for its entire length. The contour of the lamina 612 along the longitudinal direction at both sides, namely contours 671 and 672, can be of arbitrary shape, provided both are symmetrical with respect to each other. For example, the strain gauge embodiment 610 depicted in FIG. 6 has straight line shape contours 671 and 672.

Also, note that a point-distributed strain gauge of the present invention such as depicted in FIG. 6 is used to pick up strain information in a structure in its longitudinal direction. Preferably, the length of a point-distributed strain gauge should be at least about ten times its average width. This ensures that the strain signal picked up by the strain gauge sensor lamina in the direction perpendicular to the sensor longitudinal axis becomes small enough compared to that picked up in the longitudinal direction and is thus ignorable.

The preferred embodiment of the inventive point-distributed strain gauge shown in FIG. 6, as illustrated, is also symmetric with respect to the center line perpendicular to the longitudinal axis. This left-right symmetry (or, traverse symmetry, as viewed in the drawing) is necessary to maintain the targeted origin at the symmetrical center point of the strain gauge sensor lamina if the gauge is to be deployed to a three-dimensional structure for strain measurement. If either of both symmetries is distorted slightly, the targeted origin of such a strain gauge will also be shifted away slight as well. The exact location of the targeted origin of such a distorted gauge device can be resolved mathematically or numerically, and the device is as useful as the preferred embodiment as depicted in FIG. 6.

FIG. 7 is a plane view illustrating the sensor lamina shape configuration of a strain gauge apparatus in accordance with another preferred embodiment of the present invention. The strain gauge 710 has a sensor lamina 712, which, similar to gauge 610 of FIG. 6, also has a generally elongated shape. Shape of lamina 712, likewise, is symmetric with respect to its longitudinal axis. Note, however, that the lamina 712 of the gauge 710 is made on a piece of flexible carrier 740. The strain gauge 710 is an embodiment of the symmetric strain gauge apparatus of the present invention and has a targeted origin 725 at the center. The sensor lamina 712 has a pair of electrical contact terminals 713 and 714 each located at one of the far opposite ends, to be connected to electrical instrumentation for resistance measurement.

Width of the lamina 712 at the targeted origin 725, again, is substantially minimum for its entire length. The contour of the lamina 712 along its longitudinal direction at both sides, namely contours 771 and 772, is of a specific design, and both are symmetrical with respect to each other. Here, the specific contour 771 and 772 for the gauge 710 of FIG. 7 can be obtained by mathematical analysis that allows the gauge 710 to become a particular piezoresistive system that sustains only modal sensing. This allows the gauge 710 to embed itself with an inherent spatial filter. For a gauge device similar to 710 of FIG. 7 having a reduced-width center, a low-pass filter is possible. This is beneficial in many applications in which high-frequency noises are abundant in the investigated structure.

For example, the contour 771 and 772 of lamina 712 of the gauge 710 of FIG. 7 may adopt a shape determined by an exponential function e“ ”. Underlying design consideration for such a strain gauge lamina is to embed a one-order no phase-delay low-pass filter in the transfer function of the mathematical modeling system. Such an exponentially-shaped lamina contour is capable of offering an intended spatial filtering effect without causing any phase lag in its processed signal. In essence, a mathematical analysis resolves into a mathematical expression that is correspondingly for embedding a spatial filter into the strain gauge for inflicting an arbitrary no-phase-delay filtering effect when gauging strain.

The strain gauge apparatus embodiment 610 of FIG. 6 can be made as a measurement apparatus that is directly deployed onto the surface or buried inside the body of any-structure that requires strain analysis. By contrast, the strain gauge apparatus embodiment 710 of FIG. 7 is different in that it is made on the surface of a carrier sheet 740, which can be made of paper or any other suitable flexible material. This allows the gauge 710 to become off-the-shelf gauge that can be readily deployed to the surface or buried inside the body of any structure to have its strain investigated.

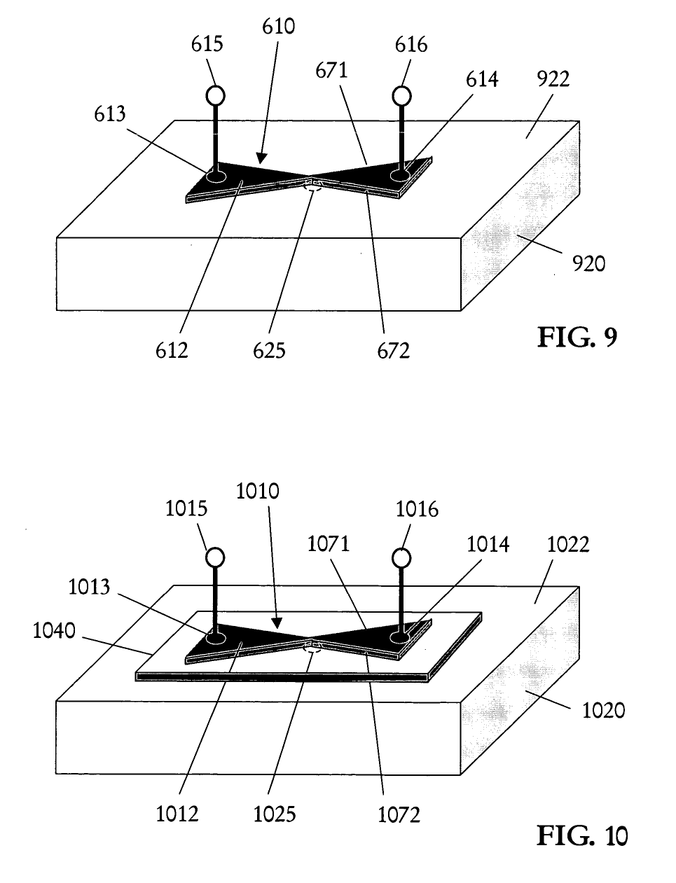

FIG. 9 is a perspective view illustrating the deployment of the strain gauge apparatus of FIG. 6 to the surface of an examined structure. Strain measurement conducted for the structure 920 of FIG. 9 utilizing a strain gauge apparatus 610 of FIG. 6 can be done by aligning the targeted origin 625 of the gauge to the precise spot on the surface 922 of structure 920. Similar as mentioned above, the strain gauge 610 is directly made on and properly bond to the surface 922 of the testes structure 920. Note that although the strain measurement setup of FIG. 9 demonstrates the measurement of surface strain, the gauge 610 can be equally suitable for internal strain investigation. As is understandable, for internal strain measurement, contact terminals 613 and 614 of the gauge need to be properly led out of the body of the investigated structure 920. This can be achievable via its lead wires connected to the electrical nodes 615 and 616 respectively.

FIG. 10 is a perspective view illustrating the deployment of the strain gauge apparatus similar to that of FIG. 7 but is made on a carrier sheet to the surface of an examined structure. Such a strain gauge apparatus 1010 is also suitable for strain measurement of surface and internal strain of any structure. It is more convenient to deploy than the gauge 610 of FIG. 6 by simply bonding the flexible carrier sheet 1040 to the test site.

FIG. 8 outlines a typical zigzagged gridwork of an embodiment of the strain gauge apparatus of the present invention that has a total of four sensor segments 831-834 physically and electrically connected in series by electrically conductive traces 881, 882 and 883. In this depicted example, the sensor segments are formed on the surface of a carrier sheet 840 (paper for example) that is flexible and can be conveniently deployed to any structure for strain measurement. Electrical contact terminals 813 and 814 provide for the measurement of resistance across the entire series of sensor segments of the gauge device 810. Although each of the sensor segments 831-834 is capable of measuring the precise strain information at its respective targeted origin, the apparatus 810 does have an effective point of measurement substantially at the point identified by the phantom circle 825.

This scheme of connecting a number of sensor segments in series is similar to that known in traditional strain gauges, as is illustrated in FIG. 2. Such is a scheme suitable for the point-distributed strain gauge of the present invention if gauge overall resistance needs to be brought up to a range acceptable to the accompanying electronic instrumentation in terms of, for example, costs. Note here that the series connection of multiple laminae is a connection that is both physically and electrically series.

Substantially, for a point-distributed strain gauge apparatus according to the present invention, all structural point covered under the piezoresistive sensor lamina except the targeted origin have their respective picked-up (sensed) signals cancelled in the inventive gauge. The signals are there, but are substantially cancelled as they are picked up by the inventive strain gauge.

By contrast, all points covered under the rectangular-shaped traditional sensors are generating their own signals and are grossly collected. All signals are aggregated as a total representation of the mixed strain characteristics for all points covered. That is why a conventional strain gauge lamina must be made as small as possible. They therefore are never “point” sensors or gauges.

Thus, the point-distributed sensor constituting the core of the inventive strain gauge apparatus in accordance with the present invention, substantially, at the same time is both a point sensor and a distributed sensor in the conventional sense. This is why the term point-distributed sensor is used to describe the inventive strain gauge. It can be considered to be a point sensor that incorporates the concept of a distributed sensor which is capable of measuring the local strain of an exact and specific point of an examined structure. This is a capability that has been impossible for the traditional point and distributed sensors to achieve.

It is noticeable that cross-sensitivity of a point-distributed strain gauge of the present invention can be minimized when the gauge is reasonably slender, or, elongated in shape. Preferably, the length of a point-distributed strain gauge constructed in accordance with the present invention should be about ten times its average width. This ensures that the strain signal picked up in the cross direction is relatively ignorable to the signal for the main sensing direction. Reduced cross-sensitivity for a strain gauge device implies improved directional sensitivity in the desired direction along which the gauge is required to sense strain.

For a gauge apparatus comprising one single point-distributed strain gauge, it is symmetric with respect to the targeted origin. Such a single-element gauge apparatus is, as mentioned, suitable for the measurement of the local strain of a specific and designated point on an examined structure. On the other hand, the series connection of multiple point-distributed strain gauges can also be used to measure strain information in all directions while the measured resistance is the average of each piezoresistive sensor that contributes its share to the gauge factor.

In summary, the present invention discloses an innovative strain gauge apparatus having a point-distributed sensor which assumes a physical configuration characteristically different from its traditional counterpart. The inventive strain gauge apparatus can achieve much better gauging performance than conventional. Experimental setups and their test results confirmed theoretical predictions of gauging characteristics of this innovative strain gauge apparatus.

While the above is a full description of the specific embodiments, various modifications, alternative constructions and equivalents may be used. Therefore, the above description and illustrations should not be taken as limiting the scope of the present invention which is defined by the appended claims.

1. A strain gauge apparatus for measuring the strain of a mechanical structure, said apparatus comprises a thin elongated piezoresistive lamina having a shape contour symmetric with respect to the longitudinal axis thereof, and the width of said lamina at the center along said longitudinal axis being minimum for the entire length thereof.

2. The strain gauge apparatus of claim 1, further comprising a contact terminal at each of both ends of said lamina for resistance measurement of said lamina.

3. The strain gauge apparatus of claim 1 wherein said mechanical structure is applied in a MEMS device.

4. A strain gauge apparatus for measuring the strain of a mechanical structure; said apparatus comprising a plurality of thin elongated piezoresistive laminae connected electrically in series, each of said plurality of laminae having a shape contour symmetric with respect to the longitudinal axis thereof, and the width of each of said laminae at the center along said longitudinal axis being minimum for the entire length thereof.

5. The strain gauge apparatus of claim 4, further comprising a contact terminal at each of both ends of said laminae series connection for resistance measurement of said laminae series.

6. The strain gauge apparatus of claim 5 wherein said longitudinal axes of said plurality of laminae being substantially parallel to one another.

7. The strain gauge apparatus of claim 6 wherein the center of each of said plurality of laminae being aligned on an axis substantially perpendicular to said parallel longitudinal axes of said laminae.

8. The strain gauge apparatus of claim 4 further comprising a flexible sheet carrier wherein said laminae series being bonded to the surface of said carrier.

9. The strain gauge apparatus of claim 1 wherein said mechanical structure is applied in a MEMS device.

10. A strain gauge apparatus for measuring the strain of a mechanical structure, said apparatus comprises a thin elongated piezoresistive lamina having a shape contour symmetric with respect to the longitudinal axis thereof, and the width of said lamina at a point between both ends of said lamina along said longitudinal axis being minimum for the entire length thereof.

11. The strain gauge apparatus of claim 10 wherein said mechanical structure is applied in a MEMS device.

12. A strain gauge apparatus for measuring the strain of a mechanical structure, said apparatus comprises a thin elongated piezoresistive lamina having a shape contour symmetric with respect to the longitudinal axis thereof and conforming to a mathematical expression that is resolved analytically for a desired embedded spatial filter for inflicting an arbitrary no-phase-delay filtering effect when gauging strain, and the width of said lamina at the center along said longitudinal axis being minimum for the entire length thereof.

13. The strain gauge apparatus of claim 12, further comprising a contact terminal at each of both ends of said lamina for resistance measurement of said lamina.

14. The strain gauge apparatus of claim 13 wherein said mechanical structure is applied in a MEMS device.

15. A strain gauge apparatus for measuring the strain of a mechanical structure; said apparatus comprising a plurality of thin elongated piezoresistive laminae connected electrically in series, each of said plurality of laminae having a shape contour symmetric with respect to the longitudinal axis thereof and conforming to a mathematical expression that is resolved analytically for a desired embedded spatial filter for inflicting an arbitrary no-phase-delay filtering effect when gauging strain, and the width of each of said laminae at the center along said longitudinal axis being minimum for the entire length thereof.

16. The strain gauge apparatus of claim 15, further comprising a contact terminal at each of both ends of said laminae series connection for resistance measurement of said laminae series.

17. The strain gauge apparatus of claim 16 wherein said longitudinal axes of said plurality of laminae being substantially parallel to one another.

18. The strain gauge apparatus of claim 17 wherein the center of each of said plurality of laminae being aligned on an axis substantially perpendicular to said parallel longitudinal axes of said laminae.

19. The strain gauge apparatus of claim 18 further comprising a flexible sheet carrier wherein said laminae series being bonded to the surface of said carrier.

20. The strain gauge apparatus of claim 15 wherein said mechanical structure is applied in a MEMS device.
